(19) United States
(12) Patent Application Publication
(10) Pub. No.: US 2005/0049765 A1
(43) Pub. Date: Mar. 3, 2005

(54) Method and apparatus for advertising assessment using location and temporal information

(75) Inventors: Alakesh Chetia, Saratoga, CA (US); Sujalendu Das, San Jose, CA (US); Gary J. Smerdon, Saratoga, CA (US)

Correspondence Address: MORRISON & FOERSTER LLP, 755 PAGE MILL RD, PALO ALTO, CA, 94304-1018, US

(73) Assignee: Sacagawea21 Inc., Saratoga, CA (US)

(21) Appl. No.: 10/817,041

(22) Filed: Apr. 2, 2004

Related U.S. Application Data
(60) Provisional application No. 60/498,386, filed on Aug. 27, 2003.

(51) Int. Cl. G01S 1/00; G06F 7/00

(52) U.S. Cl. 701/29; 342/357.09

(57) ABSTRACT

Advertisements or other announcements are transmitted from a head end to a user through a Global Positioning System (GPS) enabled or other location-aware portable device. The device also transmits locational and temporal information back to the head end. The system gathers data pertaining to the effectiveness of advertisements being communicated to the user, for example, it can be determined if the user visited the advertised business premises after listening to or watching a particular advertisement. Such gathered data allows advertisers to measure the direct impact of their advertisements.

### CROSS-REFERENCE TO RELATED APPLICATIONS

This application claims the benefit of U.S. Provisional Application No. 60/498,386, titled METHOD AND APPARATUS FOR ADVERTISING ASSESSMENT USING LOCATION AND TEMPORAL INFORMATION, filed Aug. 27, 2003, the entire content of which is incorporated herein by reference.

### STATEMENT REGARDING FEDERALLY SPONSORED RESEARCH OR DEVELOPMENT

Not applicable.

### REFERENCE TO A COMPACT DISK APPENDIX

Not applicable.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention related to computers and more specifically to use of portable computing devices to distribute advertising and similar information.

### BACKGROUND

Global Positioning System (GPS) technology is well known to provide location aware services such as navigation and finding services or points of interest around the vicinity of a user carrying a GPS-based system. Examples of commercially available GPS-based systems are the Magellan NeverLost system available on select Hertz rental cars, navigation systems on luxury cars such as BMW and Lexus, and other systems available in the retail market from companies such as Garmin, Magellan, et al. Companies such as Leadtek, Space Machine, and TeleType provide add-on hardware and software components for providing navigation functions through mobile devices such as Personal Digital Assistants (PDAs) and laptop computers. New generation location aware cellular telephones now offer navigation features and other services as well.

Such GPS-based or other (cellular telephone or WLAN) locator systems typically include a visual display where map and other directional visuals are displayed. They also have a human (user) interface allowing the user to enter information such as a destination address or select a point of interest. These devices use a well-established and proven map database from companies such as Navigation Technologies to create responses to navigational queries entered by the user. The GPS systems include a CPU subsystem for execution of software programs that provide the above functionality. The database and software programs that provide the above functionality require storage and memory to execute and store information. DVD-ROMs, disk drives and compact flash modules are typically used as the storage. Devices that plug into mobile devices such as PDAs and laptop computers typically include a GPS receiver, software and a storage medium (memory) such as compact flash memory.

End-user devices (EUD) such as cellular telephones, PDAs and laptop computers are capable of receiving, processing and communicating location (such as GPS, cellular, or WLAN positioning) information. Such devices are equipped with GPS and/or other wireless communication technologies to enable them to do so. Such wireless networking technologies include wireless local area networking (WLAN) technologies such as IEEE defined 802.11b and 802.11a standards, and wireless wide area networking technologies such as the GSM and CDMA standards followed by well known commercial wireless carriers such as ATTWS, Verizon, Sprint, etc. Hence an EUD typically has two-way wireless communications capability, although one-way (receive only) capability is possible in certain embodiments where user behavior data is downloaded later by other than wireless channels.

### SUMMARY

U.S. Pat. Nos. 5,810,680; 6,013,007; 6,389,337 and 6,529,159 disclose various different methods and apparatuses for advertising to end users based on their location as determined by a GPS enabled apparatus or device. However, none of these devices provide reporting to the advertisers regarding the impact of the advertisements on the end users using such location aware devices.

The present invention is therefore directed to a method and a system for determining the impact of an advertisement on an audience through direct measurable marketing or other data. Examples of such data are (i) how many users (i.e., end users) listened to the major part of an advertisement; and (ii) how many users used or attempted to use the goods or services advertised. These are illustrative examples only. Through the use of GPS or other locator enabled devices as described here, relevant information (advertisements being one form of such information) are provided to a user of the device based on factors such as the user's location at a given time, the time of day/week/month/year, the user's route and direction of travel or itinerary, the user's past preferences or visits (types of points of interests such as museums, landmarks, service providers, shops, businesses and such visited), etc. Then, following the playback and/or display of the relevant information, the system can determine the reaction or actions taken by the user by determining, e.g., whether the user visited the point of interest, or how long the user stayed at the point of interest.

In one embodiment, a device such as a mobile phone, PDA or any other device with a GPS receiver or cellular telephone or WLAN locator is provided with a software program performing the tasks of playing to the user relevant information and determining his response. The responses are accumulated and provided to the advertisers in the form of marketing/user data. The resulting advertisement impact assessment data as described here is expected to be highly beneficial to businesses and service providers to measure and target their advertisements. On the other hand, the users benefit by receiving highly relevant information in the form of the advertisements or other types of marketing communications.

### BRIEF DESCRIPTION OF THE DRAWINGS

FIG. 1A depicts an example of the exterior of an exemplary End User Device (EUD); a purpose built device based on existing PDA platforms and other existing technologies is shown.

FIG. 1B depicts the circuit components of the FIG. 1A EUD.

FIG. 2 is an Initialization Routine flowchart; this routine is executed by the EUD following its power up.

FIG. 3 is a Runtime Routine flowchart; this routine is executed by the EUD following completion of the Initialization Routine.

FIG. 4 is a Server Program Routine flowchart; this routine is executed by a central “head end” server computer (not shown) that communicates with the EUDs through a wireless network.

FIG. 5 is a sample of GPS data received from the GPS receiver; this data is in the National Maritime Electronics Association (NMEA) format.

FIG. 6 depicts the software components of the End User Device.

FIG. 7 depicts an exemplary zone configuration file.

FIG. 8 depicts an exemplary ASP configuration file.

FIG. 9 depicts an exemplary End User configuration file.

FIG. 10 depicts graphically on a map examples of the zone boundary, route quad zone, APOI, etc.

FIG. 11 depicts graphically a rental car center with a WLAN network.

FIG. 12 is an example of advertisement impact assessment data.

### DETAILED DESCRIPTION

The present system includes a plurality of end user devices and a central (“head end”) server computer running respectively client and server software programs. The system also utilizes in one embodiment GPS satellite signals and optionally common wireless (WLAN) and telecommunications (WWAN) networks for the EUD to central server computer communications.

The end user device (EUD) may be a modified PDA, mobile phone, general purpose computer or purpose built computing device equipped with a GPS receiver or other locator and wireless communications capability. Such devices are available today from many different sources and so are not described here in detail except insofar as the EUD is modified in accordance with the invention. Further, the end user device may be installed in an automotive vehicle and share components with electronic systems conventionally present in such a vehicle such as a GPS system, display, keypad, processor, etc. Another version of the EUD operates in conjunction with a television receiver and a set top box of the type known in the television field. This EUD transmits the location information and user preferences through a wired or wireless (e.g., WLAN, Bluetooth or infrared link) to the set top box which in turn communicates either with the cable television operator's servers at the cable television head end or with a local television server such as in a hotel. The server provides to the television receiver advertisements that are location, time, and in accordance with user specified criteria specific. The EUD detects if and what part of the advertisement the user listened to or watched and if later the user visited the advertised business.

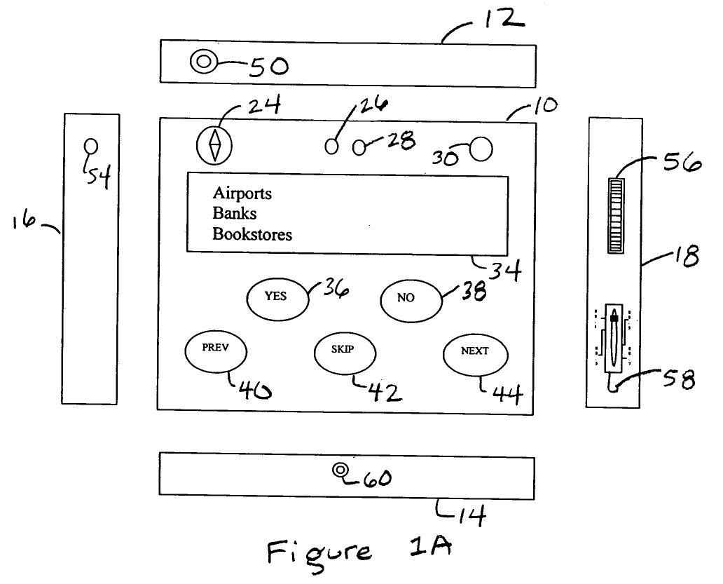

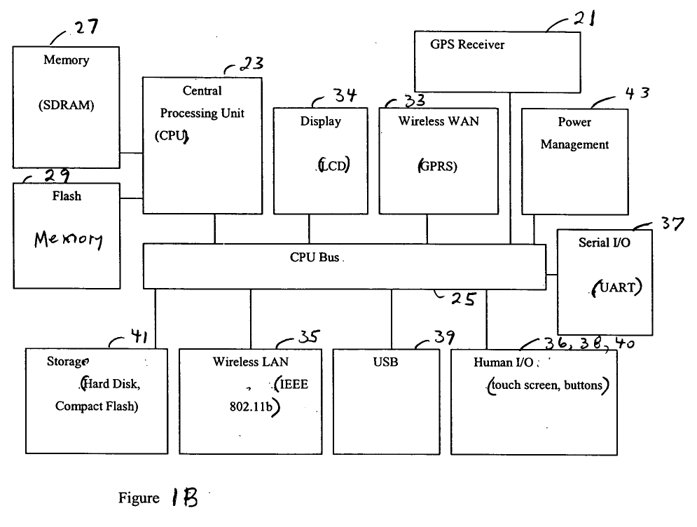

FIG. 1A shows views of exterior surfaces of one version of the EUD including the front panel 10, top side 12, bottom side 14, left side 16, and right side 18 shown in a semi-exploded view solely for purposes of illustration. The controls are largely conventional, as are the indicators and other components. In the front panel, there is a compass display 24 of the type conventional in GPS-type systems which provides an electronic display of, for instance, north-south-east-west. Adjacent are two LEDs 26 and 28 respectively colored green and red. The green LED indicates on track and the red LED indicates off track as is conventional in GPS systems. Adjacent these is the on-off button 30. Below button 30 is located a multi-line conventional LCD screen 34. Below screen 34 are Yes button 36 and No button 38, underneath which are typical control buttons respectively Previous 40, Skip 42 and Next 44. In the top side panel 12 there is an ear piece (headset) electrical connector 50 which may also include a connection to a microphone. In the left side panel 16 is a blue LED 54 used to indicate contact with a wireless LAN (WLAN). The ELD may include either cellular telephone wireless circuitry or WiFi (802.11 WLAN) circuitry or both for communications with the headend server. In this embodiment it includes WLAN circuitry only. When the EUD comes into the domain of a WLAN (Wireless Local Area Network) it may seek to connect with the head end server to transfer data/statistics stored locally in the EUD since the previous time it was in contact with the head end server.

On the right hand panel on the upper portion is a conventional scroll button 56 underneath which is located a FM radio band selector 58. The EUD when used in an automobile thereby transmits audio to the automobile's FM radio wirelessly through a FM audio transmitter integrated into the EUD. Since there may be local FM stations transmitting in particular FM frequencies, the EUD provides a choice to transmit in e.g. one of four FM frequency bands such as 88.1, 88.3, 88.5 and 88.7. If a local station is transmitting in e.g. 88.1, then the EUD's FM selector may be set to 88.3 as it is likely unused by another station. The only structure located in the lower panel 14 is a 12 volt power input connector 60 for charging the conventional internal battery.

FIG. 1B is a block diagram of the EUD circuitry; each block by itself is a conventional element and the connections therebetween are conventional. This is a modified PDA with software provided as described here, and with the addition of a GPS receiver 21 or other locator system. The other elements are a central processing unit 23; CPU bus 25, SDRAM (memory) 27; flash memory 29, display (an LCD) 34; wireless LAN circuitry (APRS) 33; wireless LAN circuitry (IEEE 802.11b) 35; serial I/O (UART) port 37; USB (Universal serial bus) port 39; human I/O buttons 36, 38, 40, 42, 44, 56, 58; non-volatile storage (a hard disk drive or compact flash memory) 41; and power management circuitry 43.

There are several methods to implement a system in accordance with this invention as computer software programs. This disclosure is directed to an object-oriented software approach and describes the program flow and the structures of the objects in the programs.

First (before the actual use by the end user of the system), Advertisement Point of Interest (APOI) Structure data, which includes Advertisement Statistics Preference Structure and Service Billing Preference Structure based data (described below) are collected from an ASP (Advertisement Service Provider) and installed in the EUD. The ASP is e.g., any business or organization providing a good or service which is being advertised through the EUD. The preferences of the ASP are collected when the ASP makes an agreement to advertise its good or service through the system. These preferences may be collected by requiring the ASP to fill in either paper or electronic forms. The information from such forms is used to programmatically populate the above data structures. A particular ASP, e.g. a gas station in a city, may want user information (statistics) covering an area of a one mile radius around the gas station while another ASP, e.g. a theme park operator, may want statistics covering a much larger area around his park.

The EUD is then provided to the end user. Advertisement, advertising, marketing communication and similar terms as used here are not limited to commercial activity, but include provision of other types of announcements, notifications, etc. broader than the usual advertising for goods and services. The announcements may be traffic/weather information, emergency notifications and such other information that has location and/or temporal relevance.

The user in the course of his normal activities while equipped with his EUD visits or tours a certain geographic area where the APOIs are located. An APOI is, e.g., a retail establishment associated with an ASP. (This is an actual physical visit, not a virtual one, to e.g. a particular city or neighborhood, on foot or by a vehicle.) The EUD in one embodiment transmits to the central server computer periodic updates of the end user's location. The periodic update of the user's location may or may not be required, depending on the particular system embodiment. If the EUD incorporates mobile phone type technology then it may update the central server periodically as to the user's location and download to the EUD marketing communications associated with that location. On the other hand, if the EUD has sufficient storage the EUD memory is loaded with all relevant marketing communications associated with a certain area, e.g. a 100 mile radius from the starting point or when the EUD was last in contact with the head end server either through cellular telephony or a WLAN. In one embodiment, a number of advertisements are locally stored in the EUD and played to the user when the EUD determines it is at or near a location relating to a particular advertisement. Further, WiFi (802.11x) based locator technologies are becoming available, such as those sold by Bluesoft Inc (www.bluesoft-inc.coin). It is possible to provide this system with such locator technologies as well in place of GPS receiver 21. The WLAN location system may in fact be complementary to GPS and cellular telephone locators by providing location information inside buildings, garages etc. where GPS or cellular telephone signals may not otherwise reach.

As the user travels through the vicinity of the APOIs, advertisements or other marketing communications are communicated to the user from a database stored in e.g. the EUD memory or at the head end (the central server computer) via the EUD. The kinds and lengths of advertisement played to the user on his EUD are context sensitive and based on locational criteria (such as the user's vicinity to the APOI, or speed of travel), temporal criteria (such as time of day or time of year) and user reaction measured through a human I/O interface on the EUD (such as pressing the “YES” button 36 or the “SKIP” button 38 on the EUD to command respectively viewing/listening or skipping of a particular advertisement).

The user's reactions (behavior) to each advertisement are thereby observed in real time by the EUD and locally stored in the EUD memory, in terms of his subsequent movements (measured by the GPS or other locator) or further use of the EUD (such as button presses on the EUD). The user's reactions are then stored in the Advertisement Statistics Structure and the Service Billing Structure maintained for each APOI. This storage may be either in the EUD memory or at the head end server depending on the particular implementation of the EUD. A cellular telephone-based EUD may have minimum local storage capacity but is able to communicate with the head end server on a regular and frequent basis, in which case the data storage can be in the head end server computer. The particular EUD described here for illustration is based on a modified PDA which unlike a cellular telephone has significant local storage capacity. In that case, the user reactions are stored locally in the EUD until the EUD comes in contact with the end server through e.g. a WLAN user, such as when a rental car with the EUD installed is returned to the rental car terminal.

The statistical results for all the APOIs associated with a certain ASP are then compiled at the head end server computer based on the preferences of the ASP and provided back to the ASP but not necessarily in real time. The preferences are the specific type of data that is relevant to the ASP. For example, the duration of stay at a particular APOI may be relevant to a particular ASP where the length of time spent has a correlation to the amount of money spent at that APOI, while in another case it may be irrelevant. An ASP may have multiple associated APOIs or just one associated APOI. For example, McDonald's Corporation will be considered an ASP if it is the entity agreeing to advertise on behalf of all of its franchise locations which are then the APOIs. On the other hand, a particular McDonald's franchise location may choose to advertise on its own in which case the ASP and the APOI are one and the same.

The EUD contains local storage in the form of either compact flash memory or a hard disk or any such storage media typically found in PDA, cellular telephone and such other devices. The client software program running on the EUD maintains software object structures such as the Advertisement Statistics Structure which are continuously updated by the client program as the user of the EUD moves around in the vicinity of an APOI. The data stored locally in the EUD is transmitted to the head end server when the EUD comes in contact with the head end server through a network which may be wired connection or a WLAN (e.g., WLAN through 802.11x or WWAN through CDMA, GPRS etc.). The compilation of the data from individual EUDs and collating them by ASPs is conventional at the head end user.

In one embodiment, the EUD is equipped with local area networking (LAN) or wide area networking (WAN) transmission capability allowing it to transmit the statistical results to the head end server which in turn collates the data by ASP and provides it to the respective ASPs using electronic channels such as the Internet or email or other conventional methods. The EUD typically does not transmit data directly to an ASP. As described above, the data from individual EUDs are collated by ASP and then sent to the ASP periodically such as weekly, monthly or quarterly by the head end server or other means. No personally identifiable user data is thereby sent to the ASPs. The data sent is of statistical and demographical type such as how many users listened to the ASP's advertisement, visited its premises, etc.

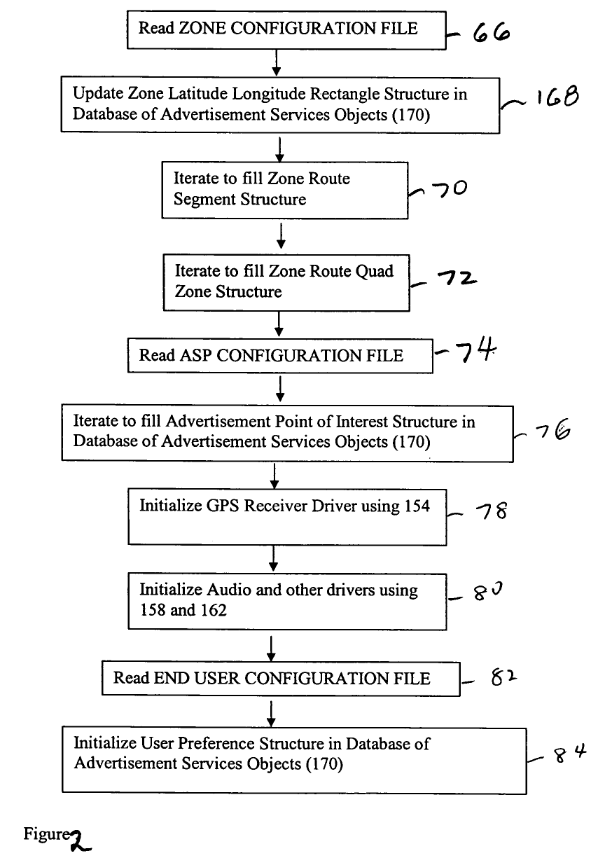

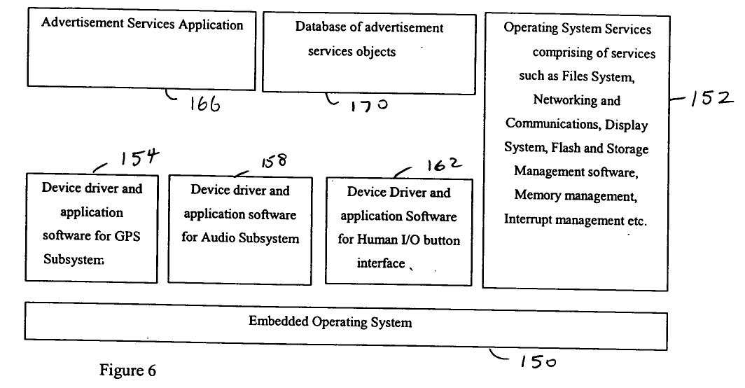

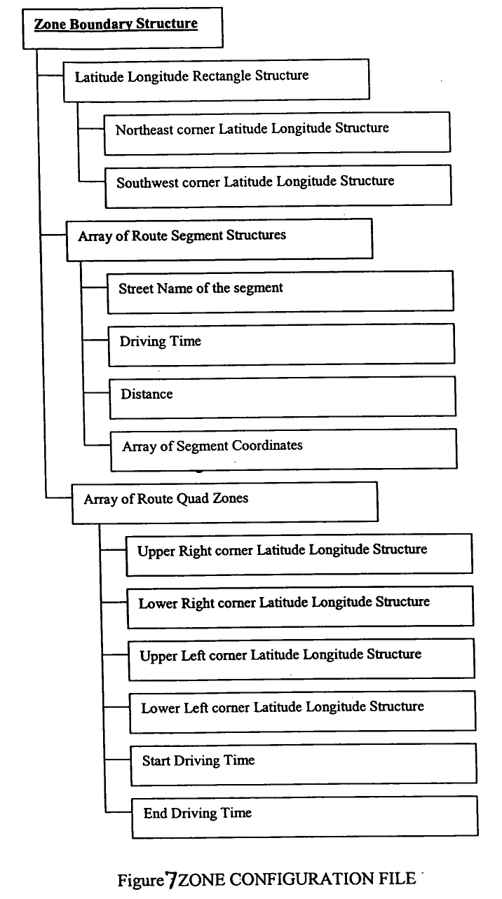

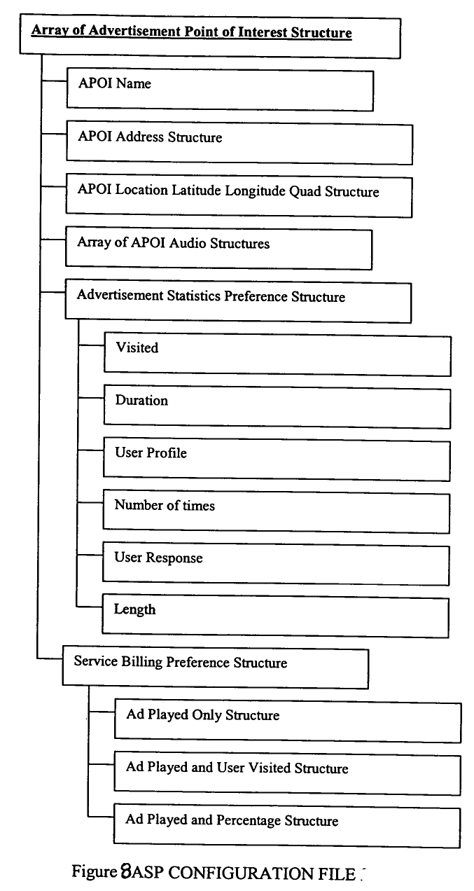

FIG. 2 shows a flow chart of the initialization routine executed by the microprocessor (CPU) 23 conventionally present in the EUD, following the EUD power up. This routine is part of the Advertisement Services application 166, see FIG. 6 showing the EUD's software components. Each time the user powers up his EUD, the first step 66 is to read the zone configuration file the structure of which is shown in FIG. 7 and which includes software objects described below. A particular geographical area is divided into several zones and sub-zones. For example, the continental United States will be a zone which is then divided into sub zones that may cover the area of one or more states or regions. Each such sub zone is further divided into smaller sub zones that may cover one or more counties or metropolitan areas. Each such zone or sub zone is defined by the latitude and longitude coordinates of the northeast and southwest corners of a minimum bounding rectangle. The zone configuration file contains these zone definitions and coordinates. After power up the EUD compares its current latitude longitude coordinates against this zone configuration file to determine in which zone and sub zone it is currently located. The next step 68 is to update the Zone Latitude Longitude Rectangular Structure. (This is a software object described in further detail below.) The next step 70 is to iterate filing the Route Segment Structure. Again this is another software object described further below. The next step 72 is to iterate filling the Zone Route Quad Zone Structure. Again this software object is described below. The next step 72 is to read the ASP configuration file the structure of which is shown in FIG. 8 and which includes a number of the software objects described in detail below.

Advertisement data used in the EUD is provided by Advertisement Server providers (ASPs). ASPs typically provide the following information:

Name and address of the commercial or other establishment for which advertisement services are to be provided. Such establishments are termed here Advertisement Points of Interest (APOI.)

Content of advertisement provided in text, audio or audio/visual format. Various lengths of content may be provided—for example introductory or detailed. Also, time-of-day or time-of-year sensitive content may be provided.

Advertisement statistics preferences describing what kinds of statistics the service provider is interested in.

Advertisement service billing preferences describing what modes of billing the service provider is interested in.

The next step at 76 is to iteratively fill the advertisement points of interest (APOI) structure. Again this is a software object described in further detail below.

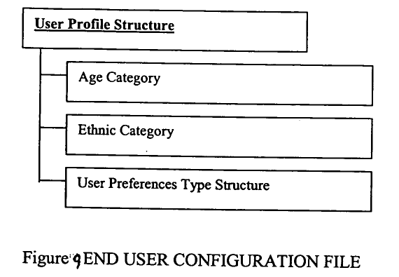

The next step at 78 is to initialize the GPS receiver driver 154 (see FIG. 6). Driver 154 is a conventional software program. Driver 154 communicates with the Operating System. 150 of FIG. 6 and provides the EUD location fixes through a defined hardware port of the EUD such as the serial port. The next step at 80 is to initiate the audio and other (software) drivers 158 and 162 (see FIG. 6) in the EUD. Next at 82 the program reads the End User Configuration File. This file is shown in exemplary form in FIG. 9 and its elements are described below. This is followed by, at 84, initialization of the User Preference Structure in the Database of advertisement services objects 170 which is also a software object described in further detail below and shown in FIG. 6. The EUD may query the user about the user's preferences at the outset and store such preferences in the end user profile structure, as described below.

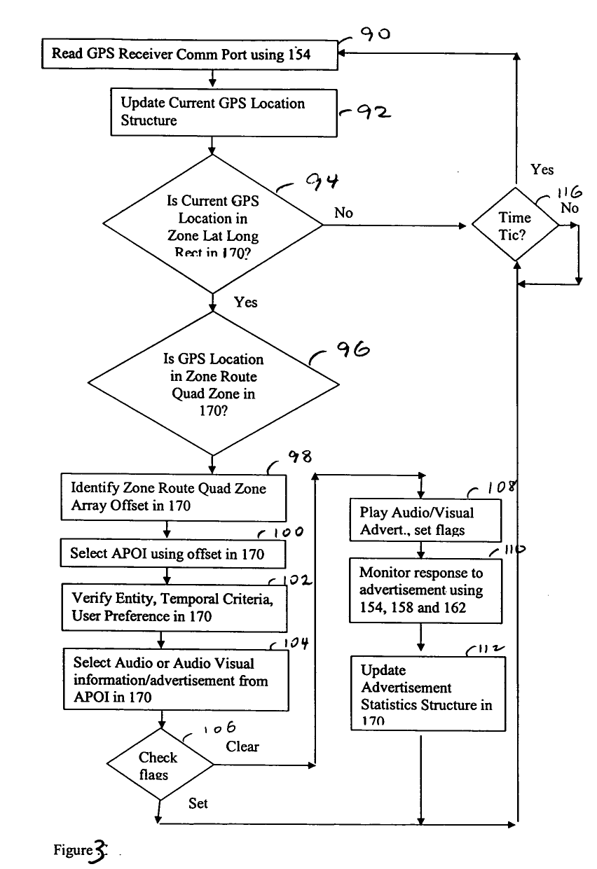

Operation of the program of FIG. 2 is further explained below in the context of FIG. 6 and is mostly conventional such as is done in a PDA or a cellular telephone. The EUD in one embodiment is a conventional PDA or mobile phone platform with certain modifications as described here such as the addition of GPS receiver or other locator, and in one embodiment also an FM audio transmitter. The initialization and operation of the Operating System 150 is conventional. The client (EUD) programs described in FIGS. 2 and 3 are executed on a conventional operating system 150 such as Windows CE/Pocket PC, Palm OS, mobile Linux.

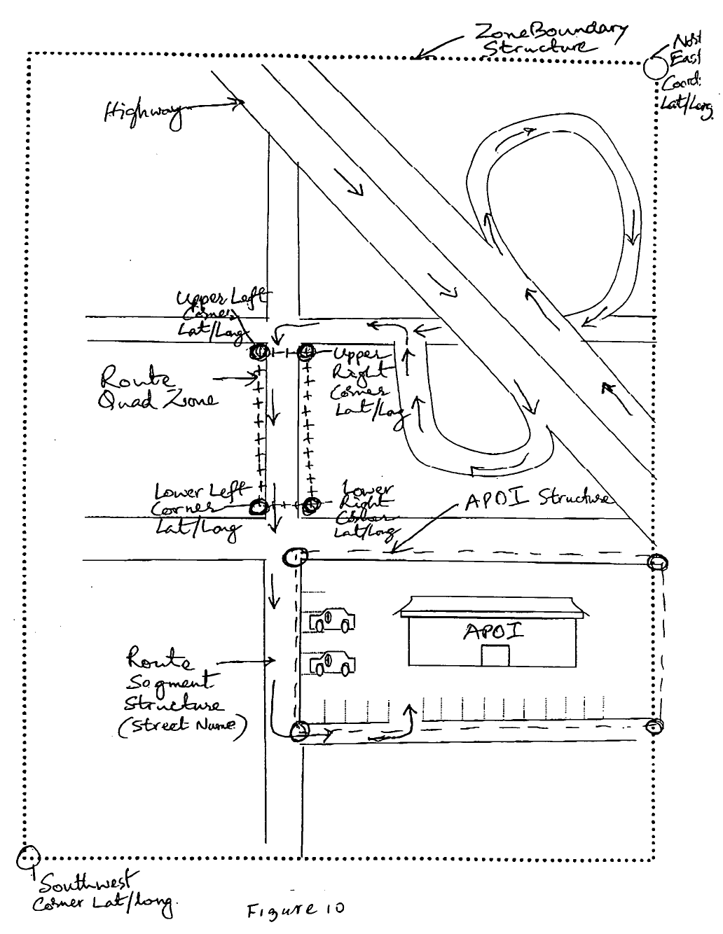

Next, the EUD microprocessor 23 executes the program shown in the Runtime Routine flow chart of FIG. 3. This is executed by the EUD following the Initialization Routine of FIG. 2 and is also part of the Advertisement Services application 166. In FIG. 3, the first step 90 is to read the status of the GPS receiver 21 communication port using driver 154. The status is the current GPS receiver 21 fix, that is, the current coordinates of latitude, longitude, time, speed etc. The next step 92 updates the current GPS location structure at 92. This object is described in further detail below. Next at step 94 the determination is made, is the current GPS (or other) location (fix) in the Zone Latitude Longitude Rectangle in Database 170 at 94. If the answer at step 94 is yes, the next step 96 is to determine if the GPS location is in the Zone Route Quad Zone in Database 170. As shown graphically in map form in FIG. 10, a route quad zone is defined as a bounding quadrilateral that encompasses a street segment of a street leading to an APOI. The definition of a route quad zone includes the latitude longitude coordinates of the four corners of the bounding quadrilateral as shown in FIG. 10. A route segment (also see FIG. 10) on the other hand defines a street segment of a street leading to an APOI by the street name.

Next at 98, the program identifies the Zone Route Quad Zone Array Offset in the Database of advertisement services objects 170. In the example shown graphically in FIG. 10, the zone boundary structure is a sub-zone within a larger zone (e.g., a city), and which contains a single APOI. When there are multiple APOIs in a zone, the offset may be used to select the relevant APOI. The following step 100 is to select the APOI using the offset in Database 170 from step 98. Next the program verifies the entity, temporal criteria and user preference in Database 170 at 102. The entity type identifies what kind of a service provider, the APOI is, for example a restaurant, book store, museum, etc. An entity may have sub-classes. For example, a restaurant may be further classified into the type of food or cuisine served. The temporal criteria determines if it is appropriate to advertise a particular APOI at the given time. For example, a restaurant that is open during lunch and dinner hours only will not be advertised during the hours it is closed. The user preference determines if a particular APOI is or could meet the user's preferences. For example, if the user has previously indicated a preference for Chinese restaurants only, then advertisements for other types of restaurants may not be displayed to that user. Next at 104 the program selects the audio or audio visual information/advertisement from the APOI in Database 170 based on the above-described criteria.

Next the FIG. 3 program checks the status of its flags at 106. The program flags determine if a particular advertisement has previously been played to a user within a certain time period. If the advertisement was previously played or a negative user response was previously determined, the associated flag is set to prevent replaying the same advertisement again and again to the same user within a certain time period. The default or initial value of a flag is Clear. The flags are then either cleared or set. If the flags are cleared, the flow of control passes to step 108 at which point the audio information and/or advertisement is displayed/played and the flags are set. Next at 110 the program monitors the user's response to the advertisement in terms of any further button presses on the EUD front panel (other modes of collecting responses may be used, for example, a EUD with a built-in microphone may accept voice responses from the user) or any subsequent location changes as determined by the EUD GPS receiver 21/locator using components 154, 158, and 162. Next at step 112 the Advertisement Statistics Structure in Database 170, which is a software object described below, is updated. If the flags are set at step 106, control instead passes directly to the time tick determination at 116. Based on the user's travel speed, density of APOIs in a certain zone and other such other factors, the program determines how frequently to read the current GPS location and loop through this program. The time tic is that variable interval of time. Flow then passes in a circular fashion back to the time tick determination or back up to the initial step 90. At step 94 if the current EUD location is not in the Zone Latitude Longitude Rectangle, then the program checks for the time tick at 116. If the EUD is in an area that is not covered, that is, outside the defined zones, then the program simply loops through reading the Current GPS (or other locator) location until such time when it finds a Current GPS location that falls within a defined zone.

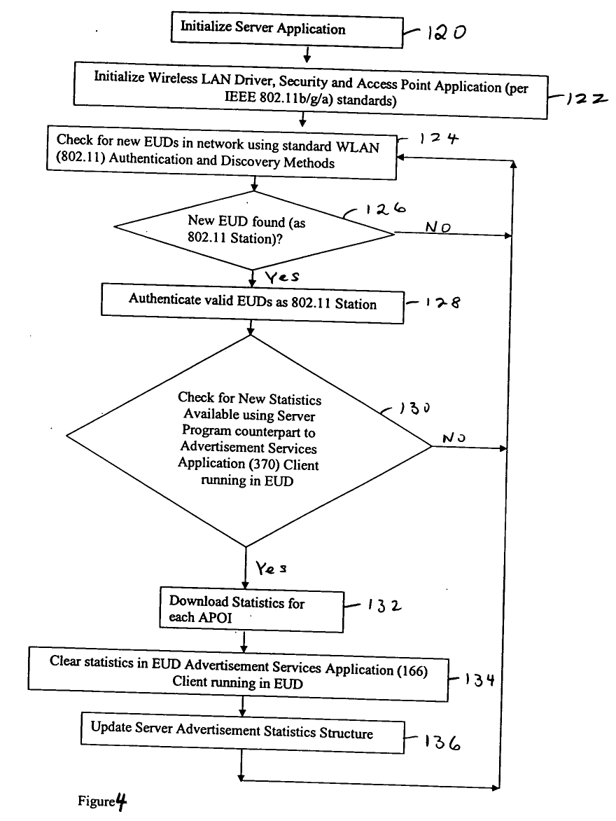

FIG. 4 is a flowchart for a complementary software program executed by the central (head end) server computer that is, e.g., in communication with the EUD through wireless communications as described above. The head end server program of FIG. 4 operates continuously. In the first step at 120, the head end server application (program) is initialized. At step 122, a WLAN driver for the head end server computer is also initialized. This is to provide WLAN communication with the WLAN circuitry 33, 35 in the EUD since the head end server has e.g., an associated WLAN transceiver. Next the program checks for new EUDs in the network, that is which EUDs are on, operating, and in contact via the wireless communications with the head end server computer. The check is done using, e.g., standard WLAN (per the IEEE 802.11 standard) authentication and discovery methods. Next at 126 if a new EUD is found to be in contact (as e.g. an 802.11 station), control passes to step 128 to authenticate that the particular EUD is valid as a station. There are many other existing, conventional methods of validation, any of which may be used. For example, in a WiFi LAN, Wireless Protected Access (WPA) standard is expected to be the industry standard for validation. WPA support is provided by the Operating System 150 such as Microsoft for Windows OS and/or the wireless communications equipment vendor. After authentication of the EUD, next it is determined at 130 if any new statistics are available. This is done using a server program counterpart to the Advertisement Services application 166 executed by the EUD. The statistics referred here to are those contained in the Advertisement Statistics Structure described above. Next, if new statistics are available, control passes to 132 at which each EUD downloads statistics for each APOI to the head end server computer. Next, at 134 the statistics in the EUD memory that have just been transmitted are cleared to allow storage of later statistics, since the EUD has limited memory capacity. When an EUD comes in contact with the head end server through a wireless or wired network such as when a rental car is returned to the rental car return center, the data collected by the EUD since the previous time this operation was done is downloaded to the head end server computer. Thereby the data is transferred out of the EUD to the head end server computer before the EUD memory is cleared. Next, at 136 the Server Advertisement Statistic Structure is updated. At this point control passes back to step 124.

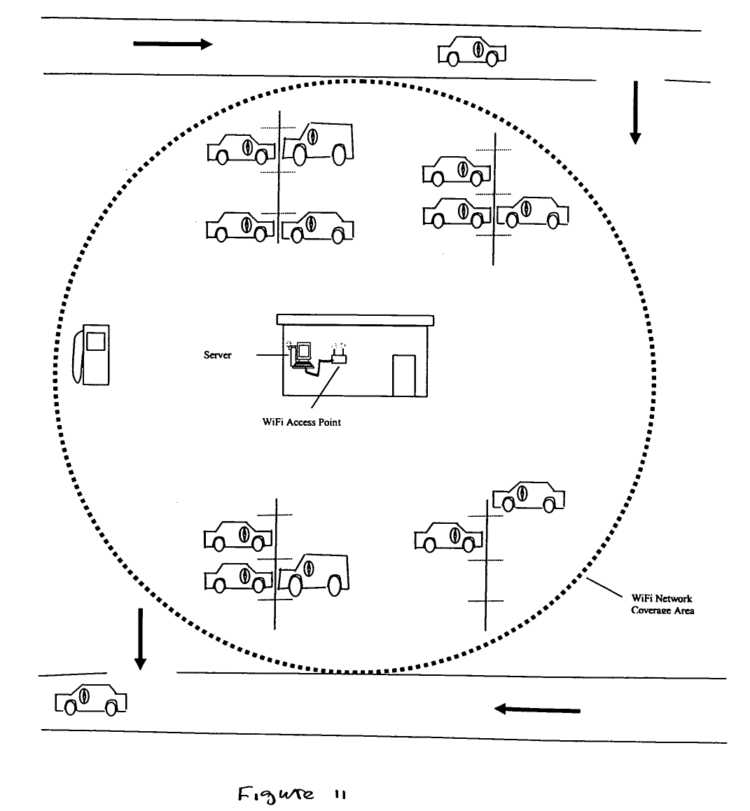

FIG. 11 depicts graphically such a rental car return center located between two streets with a WiFi access point and associated server. The WiFi access point has a particular coverage area within which it communicates with an EUD installed in each rental car.

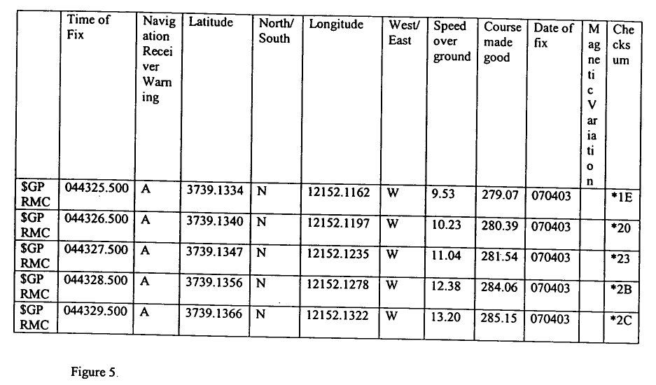

FIG. 5 is an example in tabular form of GPS (location) data (“fixes”) received from the GPS receiver in the EUD according to the well known NMEA format. The GPS driver 154 in FIG. 6 passes this data through the operating system 150 in FIG. 6 to the client software program in FIG. 3. As seen in FIG. 5, each line of the table is a single GPS data entry (fix), for which there is a “Date of Fix” which is the date of the year and also a “Time of Fix” which is the exact time of day. The fix's latitude and longitude are also provided as is conventional in GPS data. FIG. 5 shows 5 seconds worth of data. Each second, a fix is recorded and transmitted by the GPS driver to the EUD program. The first row of FIG. 5 shows the fix collected at 04 hours 43 minutes 25.5 seconds, the second row shows the fix one second later, etc. The program in FIG. 3 processes this data in step 90.

The EUD executes (but is not limited to) the software components (program modules) shown in FIG. 6. These modules are conventionally executed on the microprocessor 23 resident in the EUD, and may be coded in any suitable computer language such as C/C++, Java or any suitable language. In FIG. 6, the embedded operating system 150 and operating system services 152, respectively are, e.g., a standard off-the-shelf embedded operating system (OS), and associated software for files system management, memory management, display management, key board management, storage management (including various types of flash memory devices and hard disk drive controllers), CPU and other hardware interrupt interrupts management, OS process and application thread management and other services available in a commercially available operating system. Examples of suitable operating systems are Wind River Systems' (www.wrs.com) VxWorks version 5.4 operating system, Monta Vista's (www.mvista.com) Embedded Linux versions and Microsoft's (www.microsoft.com) Windows CE.NET v4.2 and other versions. Networking and communication stack software included in such operating systems include networking and communication software available with the operating systems described above. Examples of such components are networking device driver specification and architecture specific to the OS (example NDIS specification for Windows CE.NET from Microsoft), END specification for VxWorks from Wind River Systems), TCP, UDP and IP protocol stack components etc.

The GPS receiver 21 (locator) related software includes device driver 154 that allows communication of the GPS receiver 21 (see FIG. 1B) with the operating system 150. Typically driver 154 is a serial UART or USB (Universal Serial Bus) device driver that allows data to be received and transmitted through a communication device (such as the GPS receiver 21) connected to the UART 37 or USB port 39 of the EUD. The GPS receiver 21 as shown in FIG. 1B is connected to the CPU 23 and memory 27, 29, 41 subsystems in the EUD in a conventional manner using CPU bus 25 by which peripheral devices are connected in PDAs or cellular telephones. This may be standard serial, USB or a proprietary bus connection. The GPS device driver 154 is installed on the EUD using the device driver installation process conventionally available with the operating system 150.

Sitting “on top” (in software terms) of the device driver 154 is the Advertisement Services application software 166 that receives the GPS data from the device driver 154. Application software 166 in FIG. 6 may be implemented in any suitable computer language such as C, C++, Java etc. Application software 166 collects information about the current GPS location of the EUD using the following software structures, where the variable (object) type is specified for each object in bold.

Latitude Longitude Structure

This structure contains GPS based latitude and longitude information (see FIG. 10):

The latitude coordinate as a decimal degree value in World Geodetic System 1984 (WGS 84) datum. Double.
The longitude coordinate as a decimal degree value in WGS 84 datum. Double.

Current GPS Location Structure

This structure contains the current location of the EUD based on GPS based latitude and longitude information:

Current GPS Location: Latitude and Longitude Information. Latitude Longitude Structure.

There is also provided a device driver and application software for the EUD audio system. The EUD in one embodiment contains audio hardware including an audio controller (not shown in FIG. 1B). Device driver 158 is responsible for allowing communication of the audio controller with the embedded operating system 150 and audio encoder, decoder software and other audio processing application software available in the embedded operating system 150. In the Windows CE.NET operating system, the Windows Media Services software includes such audio application software components in the operating system services 152.

The device driver and application software 158 for the audio subsystem enables playing of audio format files (such as WMA, MP3) as included in the Advertisement Point of Interest Structure. The audio output is transmitted through the audio out jack 50 in the EUD.

There is also provided a device driver and application software 162 for the EUD Human I/O interface. The EUD (see FIG. 1A) has interface buttons 36-44 for accepting user inputs. The device driver and application software for Human I/O interface 162 are responsible for transmitting such user inputs to the operating system 150 and the Advertisement Services Application 166, also running on the EUD.

The application software 166 also processes end user inputs received by the EUD through the Human I/O interface, accomplishing the following operations:
starting or stopping the processes for communicating advertisements to the end user; tracking end user location; playing advertisements; processing end user responses while the advertisement is being played, and collecting statistical data; and collecting and processing ASP desired statistical and billing information.

There is also provided in the EUD a Database of advertisement services objects 170. This Database 170 conventionally is a software-based repository of information. It allows quick access to information stored using a key or a set of keys. Examples of well known suitable database applications are Oracle database (www.oracle.com) or the Microsoft (www.microsoft.com) SQL Access databases. The Database 170 is stored in the EUD memory 27, 29 and/or storage 41.

Directed advertisement and advertisement impact assessment feedback mechanisms as described above use certain information to be stored in Database 170. Advertisement and feedback is provided for a list of APOIs provided by Advertisement Service Providers. Each APOI is associated with an instance of Advertisement Data described later in this section. The sum-total of all instances of Advertisement Data for all APOIs forms the Database 170.

The following are examples of Database 170 record structures used in the creation and provision of advertisements for each APOI:

Route Segment Structure
Street Name: The street name of the segment. String.
Driving Time: The total driving time for a route segment in seconds. Long.
Distance: The distance of the specified route segment, in distance units (miles or kilometers) Double.
Segment Coordinates: Array of latitude and longitude coordinates falling along each segment of the route. Resolution is no less than latitude and longitude coordinates recorded, e.g., every one second when traveling at 20 miles per hour. Array Latitude Longitude Structure.

Address Structure
Street Address: The street line of an address. String.
Primary City: The name of the city of an address. String.
Secondary City: The name of the secondary city of an address in the United Kingdom. String.
Subdivision: The subdivision name (such as state or province) within the country or region for an address. String.
Postal Code: The post code, postal code, or ZIP Code of an address. String.
Country/Region: The country or region name of an address. String.

Entity Type Structure
Definition: The definition of the specified entity type. String.
Name: The descriptive name of the specified entity type. String.
Parent Name: The name of the parent Entity Type Structure of a specified entity type. String.
Properties: Describes the properties for an entity type. For example, restaurant, book store. String.

Bounding Rectangle Structure
The latitude and longitude coordinates that represent the southwest and northeast corners of a minimum bounding rectangle. Latitude Longitude Rectangle Structure.

Route Quad Zone Structure
Corner Locations: The latitude and longitude coordinates that represent the four corners of a bounding quadrilateral around an APOI. Latitude Longitude Quad Structure.
Start Driving Time: The total driving time between APOI and location on route segment that intersects with right or upper boundary of quadrilateral. Long.
End Driving Time: The total driving time between APOI and location on route segment that intersects with left or lower boundary of quadrilateral. Long.

Latitude Longitude Rectangle Structure
The latitude and longitude coordinates (Latitude Longitude Structure) for the northeast corner of a minimum bounding rectangle.
The latitude and longitude coordinates ((Latitude Longitude Structure) for the southwest corner of a minimum bounding rectangle.

Latitude Longitude Quad Structure
The latitude and longitude coordinates (Latitude Longitude Structure) for upper right corner of a bounding quadrilateral around a APOI. Latitude Longitude Structure.
The latitude and longitude coordinates (Latitude Longitude Structure) for lower right corner of a bounding quadrilateral around an APOI. Latitude Longitude Structure.
The latitude and longitude coordinates (Latitude Longitude Structure) for upper left corner of a bounding quadrilateral around a APOI. Latitude Longitude Structure.
The latitude and longitude coordinates (Latitude Longitude Structure) for lower left corner of a bounding quadrilateral around a APOI. Latitude Longitude Structure.

Zone Boundary Structure

This structure contains the following information for a zone including a list of adjacent APOIs in a geographical area such as a city or a tourist attraction:

The GPS based latitude and longitude coordinates that represent the southwest and northeast corners of a minimum bounding rectangle covering the geographical area within which APOIs are located. Latitude Longitude Rectangle Structure.
Array of route segments (street names) of the route connecting the APOIs using major or prominent streets, roads, highways etc. Route Segment Structure.
Array of route quad-zones of the route connecting the APOIs using major or prominent streets, roads, highways etc. Route Quad Zone Structure.

Advertisement Point of Interest Structure:

This structure contains the following information for each APOI:

Name: Descriptive name of APOI. String.
Address: Address of the APOI. Address Structure.
Location: Latitude and longitude coordinates for the APOI. Latitude Longitude Rectangle Structure.
Entity: Entity type of the APOI. Entity Type Structure.
Quad-Zone: Quad Zone surrounding the APOI. Route Quad Zone Structure.
Audio 1: Information about one version of audio content and contexts under which it needs to be played for the APOI. APOI Audio Structure.
Audio 2: Information about a second version of the audio content and contexts under which it needs to be played for the APOI. APOI Audio Structure. Optional.
Audio 3: Information about a third version of audio content and contexts under which it needs to be played for the APOI. APOI Audio Structure. Optional. Statistics Preference: Advertisement statistics preferences describing what kinds of statistics the provider is interested in for this APOI. Advertisement Statistics Preference Structure.
Billing Preference: Advertisement service billing preferences describing what modes of billing the service provider is interested in for this APOI. A list of service billing options is included. Service Billing Preference Structure. (“Optional” here means used or not.)

Audio Context Type Structure.
Name: Name of context type. E.g., always, evenings, mornings, summer, winter, spring etc. String.
Time of Year Property: Time of year the context time is valid. E.g., January, March -May etc.

Calendar Type Structure.
Time of Day Property: Time of day the context time is valid. E.g., 9:00 HRS to 12:00 HRS, 20:00 HRS to 23:00 HRS etc. Clock Time Type Structure.
APOI Audio Structure
   This structure contains information about audio content for an APOI such as that for an advertisement. It also contains context related information that enables playing of different content based on human I/O, temporal or spatial criteria:
APOI Name: APOI for which this Audio Structure is valid. String.
Audio file name: Name of file in audio format such as WMA or MP3. String
Duration: Duration of play for audio file in seconds. Double
Type: Type of audio content. Introductory, Medium, Long. String.
Context: Context under which audio must be played. Audio Context Type Structure.

User Profile Structure

This structure contains information about the user of the EUD. This contains user data and preferences that may be entered by the user and captures user behavior patterns to create a user profile. Such profiles are used to filter or reinforce directed advertisement and content communicated to the end user.
Age Category: Range of age where the user Falls. Age Range Type Structure.
Ethnic Category: Ethnicity Type. String.
Preferences: Pre-defined User Preference Types such as Geography, Museums, History, Bridges, Chinese Food etc. These categories map to APOI Entity Types. These entries may be entered by the user or they may be derived by the EUD based on the user's behavior while the EUD is being used. User Preferences Type Structure.

Advertisement Statistics Structure

This structure contains user behavior data, spatial (geographical) and temporal data that reflect the level of interest generated by the advertisement being communicated. Examples of parameters for this class are:

APOI Name: APOI for which this Structure is valid. String.
Speed Pattern: Speed pattern of movement of vehicle in the vicinity of a location entity for which the advertisement is being communicated. A slowing down of speed in front of a service location such as a restaurant when the restaurant advertisement is being played may indicate growing interest. Speed Pattern Structure.
User Response: User response to prompt requesting if an advertisement should be conveyed to the user. A negative response to the prompt may imply total lack of interest. Boolean.
Length: Length of time an advertisement is listened to. Double.
Additional Info: Flag indicating if additional advertisement information was requested. Boolean.
Visited: Flag indicating if the user visited the service location. Boolean.
Duration: Duration of time the user stayed at the service location. Time Type Structure.
Number or Times: Number of times the user visited the service location during a span of fixed time, for example one week in case of a car rental user, longer for others. Double.

Speed Pattern Structure
Slow Down: Boolean.
Number of times slow down: Word.
Stopped: Boolean.
Number of times stopped: Word.
Accelerate: Boolean.
Number of times accelerated: Word.

Advertisement Statistics Preference Structure

Advertisement statistics preferences describing what kinds of statistics the provider is interested in for this APOI. Note that all types except the APOI Name are Boolean to indicate if a certain statistical data needs to be recorded and provided for the APOI.
APOI Names: APOIs for which this Structure is valid. Array of Strings.
Visited: Flag indicating if the user visited the service location. Boolean.
Duration: Duration of time the user stayed at the service location. Boolean.
User Profile: Boolean.
Number or Times: Number of times the user visited the service location during a span of fixed time, for example one week in case of a car rental user, longer for others. Boolean.
User Response: User response to prompt requesting if an advertisement should be conveyed to the user. A negative response to the prompt implies total lack of interest. Boolean.
Length: Length of time an advertisement is listened to. Boolean.

Service Billing Structure

This structure contains a counter indicating the number of instances each advertisement is communicated and the duration of communication in a certain EUD apparatus. The information is recorded for providing services billing information to Advertising Service Provider.
APOI Names: APOIs for which this Service Billing Structure is valid. Array of Strings.
Advertisement Played: Number of times advertisement played, which type (Intro, Medium or Long) and percentage of the advertisement played each time. Ad Played Structure.

Service Billing Preference Structure

Advertisement service billing preferences describing what modes of billing the service provider is interested in for this APOI. A list of service billing options is included.

APOI Names: APOIs for which this Service Billing Preference Structure is valid. Array of Strings.
Ad Played Only: Bill based on whether advertisement was played only. Boolean.
Ad Played Only Bill Rate: Dollar Type Structure.
Ad Played and Percentage: Bill based on whether advertisement was played, what type and what percentage. Boolean.
Ad Played and Percentage Bill Rate: Dollar Type Structure.
Ad Played and User Visited Location: Bill based on whether advertisement was played and user stopped at location for more than a certain time (e.g., 15 minutes). Add Played and Visited Structure.
Ad Played and User Visited Location Bill Rate: Dollar Type Structure.

Therefore it can be seen that the system is capable of communicating to the user, via his end user device, various types of marketing communications which may be, for instance, an advertisement or an announcement either in the form of audio or video or still imagery. Of course, these announcements or advertisements need not be of the commercial type. The marketing communications, as typical of advertising, can relate to a good or a service. The behavioral information collected about the user using for instance the GPS (location) information and his other use of the EUD can include at any given time his location, his speed of movement, and his direction of travel.

This information collection may present privacy issues. However, typically the privacy of the individual end user is shielded from the advertiser (ASP) since the advertiser is only provided, by the head end server computer, with aggregated information (reports) about a large number of users. The operator of the head end server computer may provide assurances to the users of the EUDs that their actual movements or activities will not be tracked or reported on an individual basis. The ASP is provided aggregated user data only. In one embodiment described here, the EUD transmits to the head end server computer the data collected such as which APOIs were visited, passed by etc. only at periodic intervals when the EUD comes in contact with the head end server computer through a wired or wireless network. In the case of a continuous network connection between the EUD and the head end server computer as is possible through a WLAN or WWAN such as GPRS, the EUD may transmit current location data to the head end server computer in “real time” but such individual user information will typically not be provided to the ASP or used for active tracking purposes. This assurance of individual privacy may be given to the user by the system operator or EUD provider (which may not be the same entity).

In one embodiment, the end user initially is provided with only part of a particular marketing communication and his subsequent behavior, such as whether he entered a particular establishment (APOI) or moved in a particular direction, determines whether he receives the remaining part of the marketing communication. This provides a form of interactive advertising. The system can also determine how long the user watches or listens to the marketing communication in terms of his use of the EUD. Thus if the user terminates playing of a particular marketing communication, this information is also stored and transmitted back up to the head end server computer. If the end user requests additional information upon receipt of a marketing communication, this can also be determined, and of course the additional information would then be provided. This is similar to context sensitive “links” as well known in the Internet advertising realm. The actual physical location of the user (in terms of where the EUD is at any given time) of course is also locally stored and this determines whether for instance the user is present at a particular APOI. The length of time the user data concerning is present at that particular APOI location can also be determined, again from the GPS (or other locator) data. Also repeated visits to the same APOI location can be aggregated over, for instance, a week.

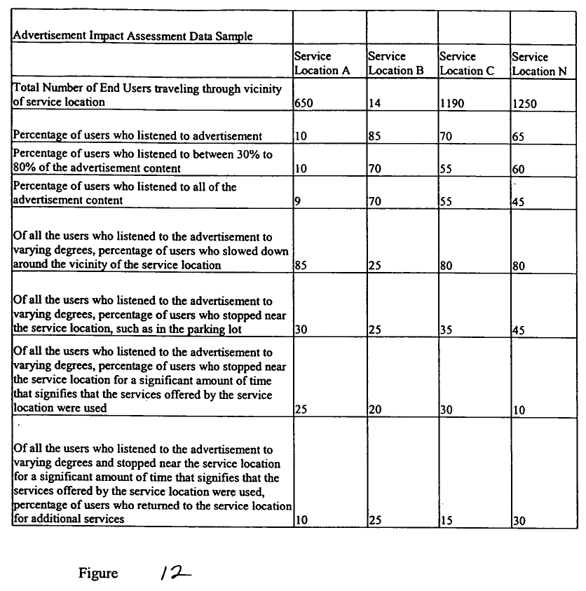

In the typical situation, the data is aggregated at the head end server computer by ASP and/or by user. The resulting data may be provided to the ASPs in the form of reports to enable the ASP to measure the impact of its advertisement and/or a measure of the condition of its market. An example of a type of report thereby provided to the ASP is shown in FIG. 12. The user profile and demographic data may be used to determine a profile of the individual user which can then be aggregated with other such profiles, as conventional in the marketing field. The mode by which the information about user behavior is transmitted back to the head end server computer can vary. In one embodiment, this information is sent in real time, with all further data processing done by the head end server computer. In another embodiment the user activity information is stored locally at the EUD and periodically (hourly, daily, etc.) transmitted to the head end server computer. In another embodiment, the information is stored locally and only transmitted back upon occurrence of a predetermined event, such as a return of a rental car in which the EUD is installed (as in FIG. 11). In this case the data transmission need not be of the wireless variety, and could be by use of a memory card or memory cartridge or a wired connection.

Suitable software may be coded for both the head end server computer and the EUD in light of this description. This disclosure is illustrative and not limiting; further modifications will be apparent to one skilled in the art in light of this disclosure and are intended to fall within the scope of this invention as defined by the appended claims.

1. A method comprising the acts of:
providing a portable computing device;
determining a geographical location of the device;
storing the geographical location;
transmitting from a remote location to the device a marketing communication that relates to the determined location;
providing the transmitted marketing communication to a user of the device;
determining, by the device, a behavior of the user subsequent to the provision of the marketing communication; and
transmitting information concerning the determined behavior from the device.

2. The method of claim 1, wherein determining the geographical location comprises using one of a global positioning system, a cellular telephone system locator, or a wireless local area network locator.

3. The method of claim 1, wherein the marketing communication includes at least one of an advertisement or an announcement.

4. The method of claim 1, wherein the announcement is non-commercial.

5. The method of claim 1, wherein the marketing communication relates to at least one of a good or a service.

6. The method of claim 1, wherein transmitting the geographical location uses one of a cellular telephone system, a wide area network, or a wireless local area network.

7. The method of claim 1, wherein the determined behavior includes at least one of a speed or direction of travel of the user.

8. The method of claim 1, wherein initially the user is provided only a part of the marketing communication and the determined behavior includes a response by the user as to whether the user wants to be provided with a remainder of the marketing communication.

9. The method of claim 1, wherein the determined behavior includes a length of time the user watches or listens to the marketing communication.

10. The method of claim 1, wherein the determined behavior includes whether the user watches or listens to the marketing communication.

11. The method of claim 1, wherein the determined behavior includes whether additional information is requested by the user.

12. The method of claim 1, wherein the determined behavior includes whether the user was at a location specified in the marketing communication.

13. The method of claim 12, wherein the determined behavior includes a length of time the user was at the specified location.

14. The method of claim 12, wherein the determined behavior includes a number of times the user was at the specified location over a predetermined time period.

15. The method of claim 1, wherein the device is selected from the group consisting of a cellular telephone, a personal digital assistant, and a portable computer.

16. The method of claim 1, further comprising the acts of:
determining a profile of the user using the transmitted information.

17. The method of claim 1, further comprising the acts of:
providing at least a portion of the transmitted information to a provider of the marketing communication; and
obtaining payment in exchange for the provision of the transmitted information.

18. The method of claim 1, wherein the marketing communication is originated by a provider, and further comprising the act of communicating the marketing communication from the provider to a central server.

19. The method of claim 18, wherein the provider is a provider of at least one of a good or a service.

20. The method of claim 1, further comprising the act of transmitting the stored geographical location to the remote location.

21. The method of claim 1, further comprising the act of installing the portable computing device in a vehicle.

22. The method of claim 1, further comprising the act of displaying the marketing communication on a television receiver associated with the portable computing device.

23. A portable computing device comprising:
a wireless transceiver;
a locator;
an output portion;
storage; and
a processor operatively connected to each of the wireless transceiver, locator, output portion and storage, wherein the processor receives from the locator an indication of a geographical location of the apparatus, receives from the wireless transceiver a marketing communication transmitted to the wireless transceiver and controls output of the marketing communication on the output portion, determines subsequent behavior of a user, and stores the information concerning the subsequent behavior in the storage.

24. The device of claim 23, wherein the locator comprises one of a global positioning system, a cellular telephone system locator or a wireless local area network locator.

25. The device of claim 23, wherein the marketing communication includes at least one of an advertisement or an announcement.

26. The device of claim 23, wherein the announcement is non-commercial.

27. The device of claim 23, wherein the marketing communication relates to at least one of a good or a service.

28. The device of claim 23, wherein the transceiver is one of a cellular telephone, a wide area network node, or a wireless local area network node.

29. The device of claim 23, wherein the behavior includes at least one of a speed or direction of travel of the user.

30. The device of claim 23, wherein initially the processor provides only a part of the marketing communication and the behavior includes a response by the user to the processor as to whether the user is provided with a remainder of the marketing communication by the processor.

31. The device of claim 23, wherein the behavior includes a length of time the user watches or listens to the marketing communication.

32. The device of claim 31, wherein the behavior includes whether the user watches or listens to the marketing communication.

33. The device of claim 23, wherein the behavior includes whether additional information is requested by the user.

34. The device of claim 23, wherein the behavior includes whether the user was at a location specified in the marketing communication.

35. The device of claim 34, wherein the behavior includes a length of time the user was at the specified location.

36. The device of claim 34, wherein the behavior includes a number of times the user was at the specified location over a predetermined time period.

37. The device of claim 23, wherein the device is selected from the group consisting of a cellular telephone, a personal digital assistant, and a portable computer.

38. The device of claim 23, wherein the device is installed in a vehicle.

39. The device of claim 23, wherein the marketing communication is displayed on a television receiver associated with the portable computing device.

40. A method comprising the acts of:
providing a portable computing device;
determining a geographical location of the device;
providing the device with a plurality of marketing communications for a user in response to the determined geographical location;
determining, by the device, behavior of the user subsequent to the provision of the marketing communication to the user; and
storing information concerning the determined behavior.

41. The method of claim 40, wherein providing the device with a plurality of marketing communications includes transmitting the determined geographical location to a remote location and in response transmitting the plurality of marketing communications from the remote location to the device.

42. The method of claim 40, wherein providing the user at least one of the marketing communications includes selecting one of the plurality of marketing communication stored in the device.

43. The method of claim 40, wherein storing the information is performed at the device.

44. The method of claim 40, wherein storing the information is performed at a remote location.

45. The method of claim 43, further comprising the acts of:
transmitting the stored information to a remote location;
aggregating the stored information with information pertaining to other users; and
reporting the aggregated information.

46. The method of claim 40, further comprising the act of installing the portable computing device in a vehicle.

47. The method of claim 40, further comprising the act of displaying one of the marketing communications on a television receiver associated with the portable computing device.
